(19) United States
(12) Patent Application Publication
(10) Pub. No.: US 2011/0162477 A1
(43) Pub. Date: Jul. 7, 2011

(54) ROBOT

(75) Inventors: Hong Won KIM, Seoul (KR); Woo Sup Han, Yongin-si (KR)

(73) Assignee: SAMSUNG ELECTRONICS CO., LTD., Suwon (KR)

(21) Appl. No.: 12/985,433

(22) Filed: Jan. 6, 2011

(30) Foreign Application Priority Data
Jan. 7, 2010 (KR) 10-2010-0001365

(51) Int. Cl. B25J 17/00

(52) U.S. Cl. 74/490.05

(57) ABSTRACT

A robot forms a natural curved line through a thickness variation of an outer cover member such that a user feels friendly toward gestures expressed by the robot. The robot includes a plurality of link members, at least one joint hinge connecting the plurality of link members, and an outer cover member covering the plurality of link members and the at least one joint hinge, wherein, as the outer cover member gets close to the at least one joint hinge, the thickness of the outer cover member increases.

### CROSS-REFERENCE TO RELATED APPLICATION

This application claims the priority benefit of Korean Patent Application No. 10-2010-0001365, filed on Jan. 7, 2010 in the Korean Intellectual Property Office, the disclosure of which is incorporated herein by reference.

### BACKGROUND

1. Field

Embodiments relate to a robot which forms a natural curved line through a thickness variation of an outer cover member.

2. Description of the Related Art

Communication between robots and humans has been increased according to development of robotics. Various techniques for non-verbal communication between robots and humans have been developed.

In one example of the non-verbal communication, there is a gesture. The gesture means a motion or a sign used to add an effect to language. A robot is capable of expressing feelings or intentions through gestures.

However, the robot includes link members and joints, and thus is weak in expressing gestures. That is, if the robot is formed in a curved shape, the robot easily expresses gestures. But, since it is generally difficult form the robot in the curved shape only using the link members and the joints, the robot does not easily express gestures.

In order to achieve the curved shape of the robot, the robot may include multiple link members and multiple joints. Therefore, as the number of the link members and the number of the joints increase, the robot motion control becomes increasingly difficult. Further, the curved shape expressed by the link members and the joints is not natural, and thus feeling or intention expression of the robot is not natural.

### SUMMARY

Therefore, it is an aspect to provide a robot which forms a natural curved line through a thickness variation of an outer cover member such that a user feels friendly toward gestures expressed by the robot.

Additional aspects of the invention will be set forth in part in the description which follows and, in part, will be obvious from the description, or may be learned by practice of the invention.

In accordance with one aspect, a robot includes a plurality of link members, at least one joint hinge connecting the plurality of link members, and an outer cover member covering the plurality of link members and the at least one joint hinge, wherein, as the outer cover member gets close to the at least one joint hinge, the thickness of the outer cover member increases.

The robot may further include at least one fixing member connecting the outer cover member and the at least one joint hinge.

The outer cover member may include first thickness parts corresponding to the fixing members, and at least one second thickness part having a smaller thickness than that of the first thickness parts corresponding to the plurality of link members.

As the at least one second thickness part gets distant from the fixing members, the thickness of the at least one second thickness parts may decrease.

The at least one fixing member may be fixed between the plurality of link members by the at least one joint hinge.

The at least one fixing member may be fixed to one of the plurality of link members.

The outer cover member may be changed into a curved shape.

The outer cover member may be made of an elastic and flexible material.

The outer cover member may include at least one first outer cover part connected to the at least one fixing member to have a designated thickness, and a second outer cover part made of an inelastic material and covering the at least one first outer cover part.

The plurality of link members may be provided in a rectilinear shape.

In accordance with a further aspect, a robot includes a plurality of link members connected by joints, and an outer cover member covering the plurality of link members, wherein the outer cover member includes first thickness parts covering the joints, and second thickness parts covering the remaining parts excluding the joints, and the first thickness parts have a greater thickness than that of the second thickness parts.

In accordance with another aspect, a robot includes a plurality of link members connected by joints, an outer cover member covering the plurality of link members, and fixing members formed corresponding to the joints between the plurality of link members and the outer cover member, wherein the outer cover member is made of an elastic material such that, as the outer cover member gets distant from the fixing members, the thickness of the outer cover member decreases.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating a robot in accordance with one embodiment in a state in which the robot does not express a gesture;

FIG. 2 is a view illustrating the robot in accordance with the embodiment in a state in which the robot expresses a gesture;

FIG. 3 is an enlarged view illustrating joints of FIG. 2;

FIG. 4 is view illustrating connection of an outer cover member and joints of a robot in accordance with another embodiment;

FIG. 5 is a view illustrating a shape of the outer cover member of the robot of FIG. 4 in a state in which the robot expresses a gesture;

FIG. 6 is a view illustrating a modification of the connection of the outer cover member and the joints of the robot of FIG. 4;

FIG. 7 is a view illustrating a shape of the outer cover member of the robot of FIG. 6 in a state in which the robot expresses a gesture; and

FIGS. 8 and 9 are views illustrating modifications of a connection method of a fixing member, a link member, and a joint hinge of FIG. 4.

### DETAILED DESCRIPTION

Reference will now be made in detail to the embodiments, examples of which are illustrated in the accompanying drawings, wherein like reference numerals refer to like elements throughout.

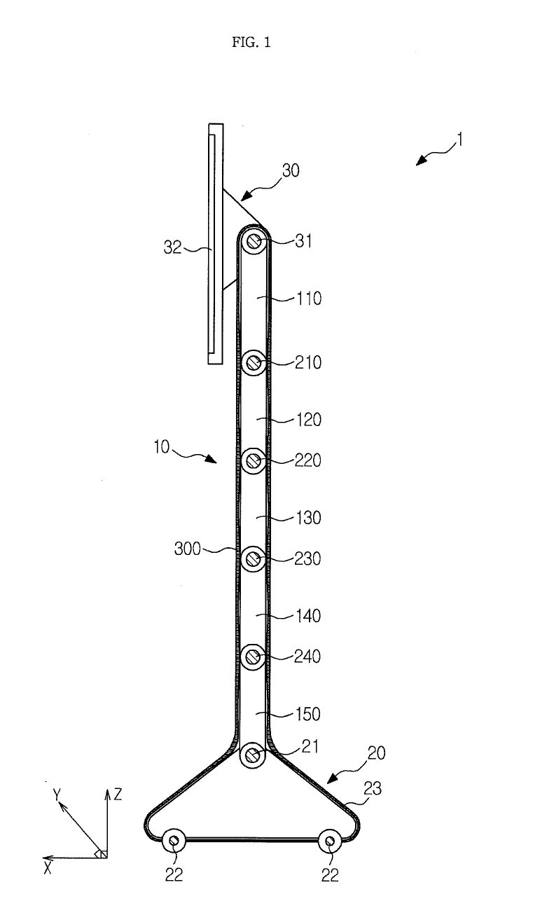

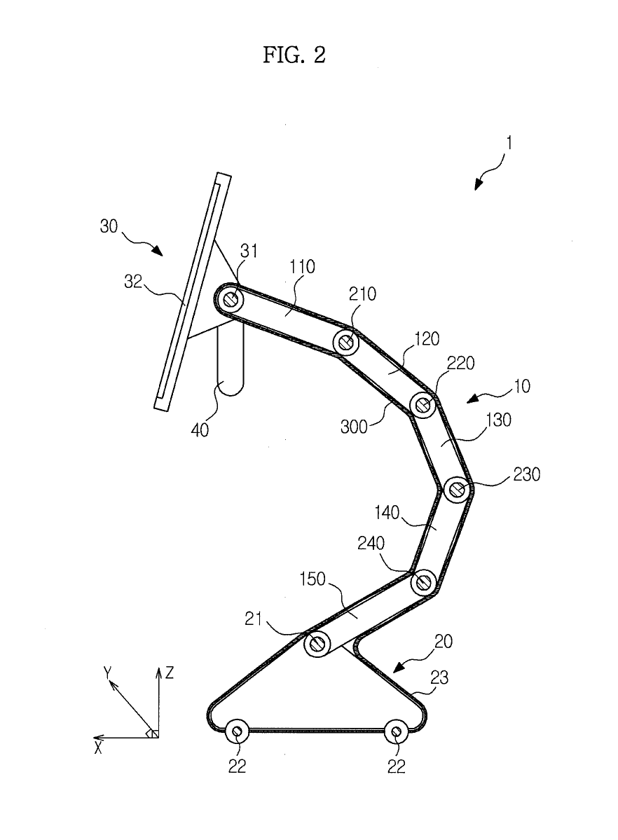

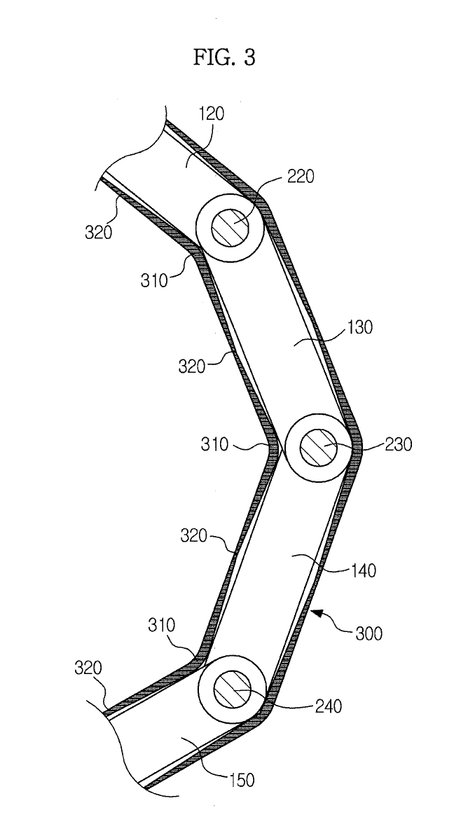

FIG. 1 is a view illustrating a robot in accordance with one embodiment in a state in which the robot does not express a gesture, FIG. 2 is a view illustrating the robot in accordance with the embodiment of the present invention in a state in which the robot expresses a gesture, and FIG. 3 is an enlarged view illustrating joints of FIG. 2.

As shown in FIGS. 1 to 3, a robot 1 in accordance with one embodiment forms a natural curved line, thereby allowing a user to feel friendly toward gestures expressed by the robot. If the robot 1 is formed in a streamlined shape, the robot 1 may express gestures through the shape thereof. Here, the streamlined shape denotes a natural curved line of the robot 1 such that a human recognizes feelings or intentions expressed by the robot 1 through non-verbal communication between the robot 1 and the human.

The robot 1 in accordance with this embodiment includes a body 10, a support 20, a head 30, and an arm 40. Particularly, the robot 1 changes the shape of the body 10 into a curved shape, such as a streamlined shape, thereby expressing gestures.

The body 10 may include a plurality of link members 110˜150, a plurality of joints 210˜240, and an outer cover member 300.

The plural link members 110˜150 may include a first link member 110, a second link member 120, a third link member 130, a fourth link member 140, and a fifth link member 150. The first to fifth link members 110˜150 may be respectively formed in a rectilinear shape.

The plural link members 110˜150 may be respectively rotated in two directions which are perpendicular to each other. That is, the plural link members 110˜150 are rotated in the direction X and direction Y by the plural joints 210˜240. Thus, the shape of the body 10 may be changed by rotary motions of the plural link members 110˜150.

The plural joints 210˜240 includes a first joint 210 connecting the first link member 110 and the second link member 120, a second joint 220 connecting the second link member 120 and the third link member 130, a third joint 230 connecting the third link member 130 and the fourth link member 140, and a fourth joint 240 connecting the fourth link member 140 and the fifth link member 150, respectively.

The first to fourth joints 210˜240 may include first to fourth joint hinges 210˜240 connecting the first to fifth link members 110˜150 respectively. Of course, the first to fourth joints 210˜240 may use other members of various methods in addition to the first to fourth joint hinges so long as the first to fourth joints 210˜240 are sufficient to movably connect the plural link members 110˜150.

The outer cover member 300 covers the plural link members 110˜150 and the plural joint hinges 210˜240, and the shape thereof may be changed according to changes in the shapes of the plural link members 110˜150. Further, due to the nature of a material of the outer cover member 300, the outer cover member 300 has a natural curved shape when the shape of the outer cover member 300 is changed. Thereby, the body 10 is formed in a natural curved shape by the outer cover member 300, and thus the robot 1 may express gestures using the body 10.

The outer cover member 300 includes first thickness parts 310 corresponding to the respective joint hinges 210˜240, and second thickness parts 320 corresponding to the link members 110˜150 and having a smaller thickness than that of the first thickness parts 310.

The outer cover member 300 is formed by sequentially repeating the relatively thick first thickness parts 310 and the relatively thin second thickness parts 320. The second thickness parts 320 of the outer cover member 300 have a smaller thickness than that of the first thickness parts 310, thus having higher flexibility or elasticity than that of the first thickness parts 310.

That is, since the first thickness parts 310 of the outer cover member 300 adjacent to the joint hinges 210˜240 are thick, when the link members 110˜150 are rotated around the joint hinges 210˜240, the first thickness parts 310 of the outer cover member 300 at regions adjacent to the joint hinges 210˜240 have a small curvature and the second thickness parts 320 of the outer cover member 300 at regions distant from the joint hinges 210˜240 have a large curvature, thus allowing the outer cover member 300 to be formed in a natural curved shape.

The support 20 is movably provided while supporting the body 10. The support 20 is connected with the body 10 by a lower joint 21. Further, wheels 22 are provided on the support 20, thereby allowing the robot 1 to move.

The head 30 is supported by the body 10. The head 30 is connected with the body 10 by an upper joint 31. The head 30 may include a display device 32 to display data. The head 30 may express gestures together with the body 10.

The arm 40 is supported by the body 10. The arm 40 is connected with the body 10 by a shoulder joint (not shown). The arm 40 may express gestures together with the body 10.

The support 20 may be covered with a separate outer cover member 23. The outer cover member 23 covering the support 20 may be formed integrally with the outer cover member 300 covering the plural link members 110˜150, or may be formed separately from the outer cover member 300. Further, the head 30 and the arm 40 may be covered with separate outer cover members (not shown), respectively.

Since a lower end of the outer cover member 300 is opened, the plural link members 110˜150 may be inserted into the body 10 through the opened lower end of the outer cover member 300. In this case, the lower end of the outer cover member 300 may be fixed to a lower end of the fifth link member 150, and an upper end of the outer cover member 300 may be fixed to an upper end of the first link member 110. Here, various methods, such as screw connection, may be used to achieve the fixation of the outer cover member 300 to the lower end of the fifth link member 150.

In the fixation of the outer cover member 300, the fixation of the outer cover member 300 to both ends of the plural link members 110˜150 allows the outer cover member 300 to have a more natural curved line, thus allowing the body 10 to have a natural curved line.

The robot 1 in accordance with this embodiment forms a natural curved line through a thickness variation of the outer cover member 300 such that a user feels friendly toward gestures expressed by the robot 1, thereby achieving feeling expression or intention expression through non-verbal communication.

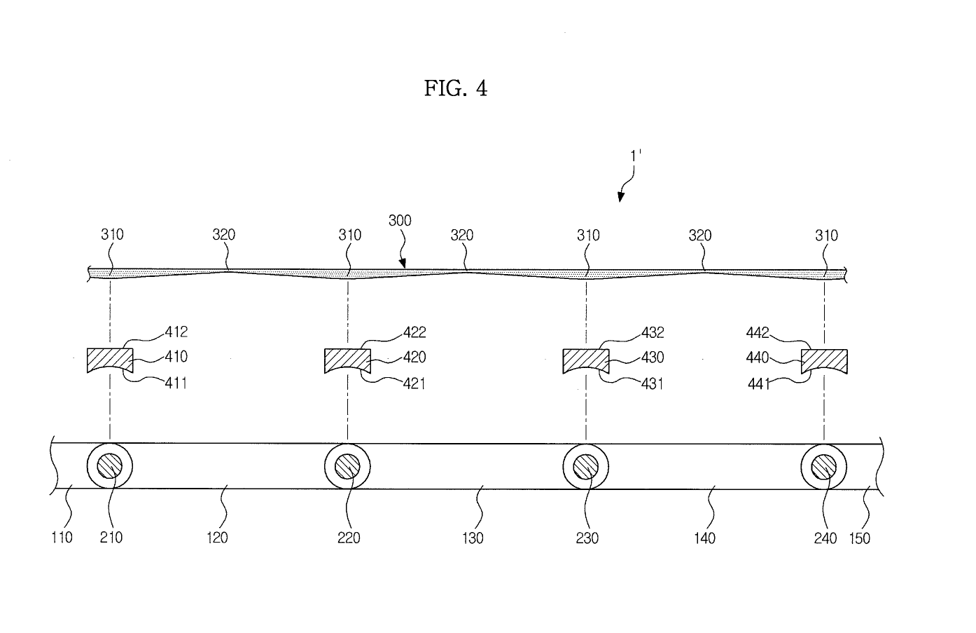

Hereinafter, a robot in accordance with another embodiment will be described with reference to FIGS. 4 to 7. Some parts in this embodiment, which are substantially the same as those in the earlier embodiment, will be denoted by the same reference numerals even though they are depicted in different drawings.

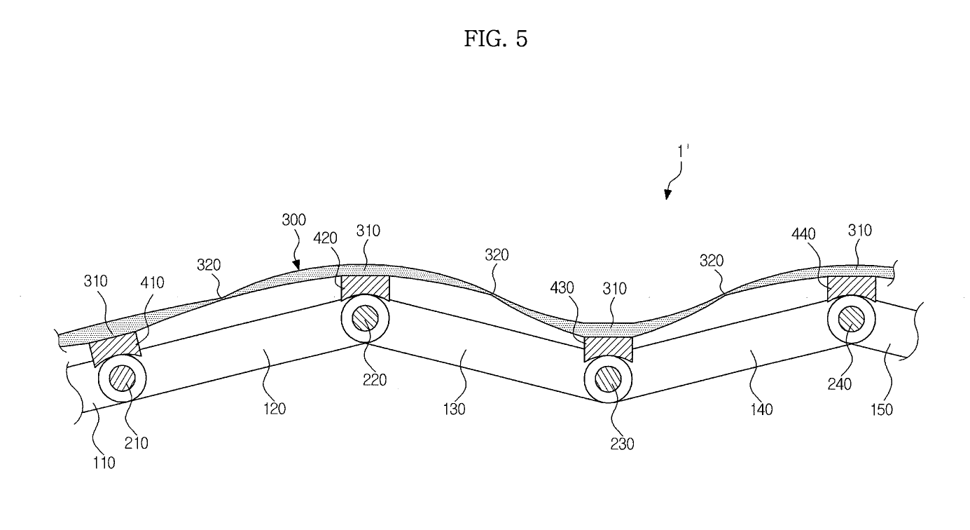

FIG. 4 is view illustrating connection of an outer cover member and joints of the robot in accordance with this embodiment, and FIG. 5 is a view illustrating a shape of the outer cover member of the robot of FIG. 4 in a state in which the robot expresses a gesture.

As shown in FIGS. 4 and 5, a robot 1′ in accordance with this embodiment includes a plurality of link members 110˜150 connected by joints 210˜240, an outer cover member 300 covering the plural link members 110˜150, and fixing members 410˜440 formed corresponding to the joints 210˜240 between the link members 110˜150 and the outer cover member 300.

The outer cover member 300 includes first thickness parts 310 corresponding to the fixing members 410˜440, and second thickness parts 320 corresponding to the link members 110˜150 and having a smaller thickness than that of the first thickness parts 310.

The outer cover member 300 is formed by sequentially repeating the relatively thick first thickness parts 310 and the relatively thin second thickness parts 320. The second thickness parts 320 of the outer cover member 300 have a smaller thickness than that of the first thickness parts 310, thus having higher flexibility or elasticity than that of the first thickness parts 310.

The fixing members 410˜440 respectively include first fixing parts 411˜441 contacting the plural link members 110˜150 connected by the joints 210˜240, and second fixing parts 412˜442 contacting the first thickness parts 310 of the outer cover member 300.

The first fixing parts 411˜441 are formed in a concave plane to be closely attached to the joints 210˜240, and the second fixing parts are formed in a flat plane to be closely attached to the outer cover member 300.

Therefore, when the link members 110˜150 are rotated around the joints 210˜240 within the flexible outer cover member 300, the joints 210˜240 transmit external force to the fixing members 410˜440, and the shape of the outer cover member 300 is changed by the external force transmitted to the fixing members 410˜440.

The fixing members 410˜400 prevent the outer cover member 300 from being pushed or coming off the link members 110˜150 due to the shape or connection characteristics of the fixing members 410˜440. Further, since the first thickness parts 310 of the outer cover member 300 closely attached to the second fixing parts 412˜442 of the fixing members 410˜440 are thick, the first thickness parts 310 at regions around the fixing members 410˜440 have a small curvature and the second thickness parts 320 at regions distant from the fixing members 410˜440 have a large curvature, thus allowing the outer cover member 30 to be formed in a natural curved shape although the link members 110˜150 are formed in a rectilinear shape.

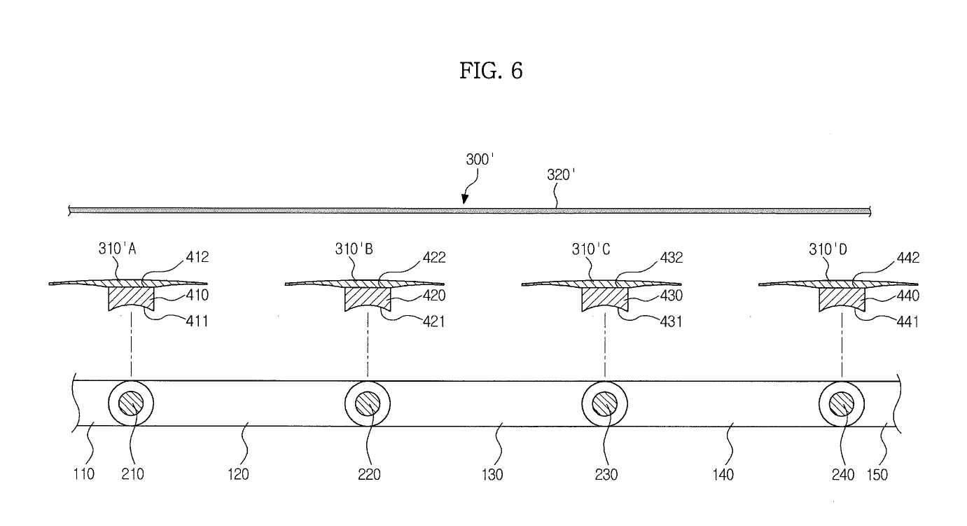

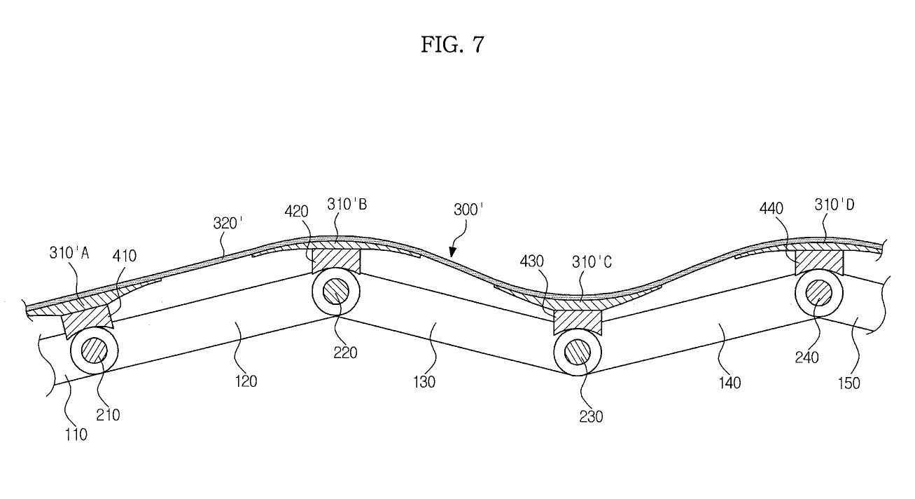

FIG. 6 is a view illustrating a modification of the connection of the outer cover member and the joints of the robot of FIG. 4, and FIG. 7 is a view illustrating a shape of the outer cover member of the robot of FIG. 6 in a state in which the robot expresses a gesture.

As shown in FIGS. 6 and 7, the robot 1′ includes a plurality of link members 110˜150 connected by joints 210˜240, an outer cover member 300′ covering the plural link members 110˜150, and fixing members 410˜440 formed corresponding to the joints 210˜240 between the link members 110˜150 and the outer cover member 300′. The outer cover member 300′ includes first outer cover parts 310′A˜310′D connected to the fixing members 410˜440, and a second outer cover part 320′ made of an inelastic material so as to cover the first outer cover parts 310′A˜310′D.

The first outer cover parts 310′A˜310′D having a designated thickness are respectively connected to the fixing members 410˜440, and the second outer cover part 320′ having another designated thickness is connected to the first outer cover parts 310′A˜310′D so as to cover the first outer cover parts 310′A˜310′D.

The first outer cover parts 310′A˜310′D, which serve as connection members between the respective fixing members 410˜440 and the second outer cover part 320′ made of the inelastic material, are formed in a curved shape corresponding to the link members 110˜150, and are connected to the second outer cover part 320′ made of the inelastic material, thereby forming a natural curved shape of the outer cover member 300′.

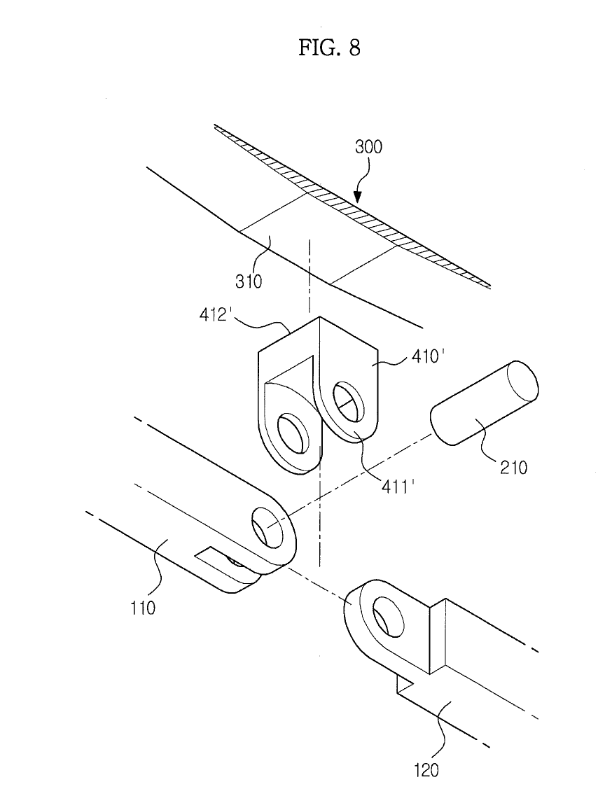

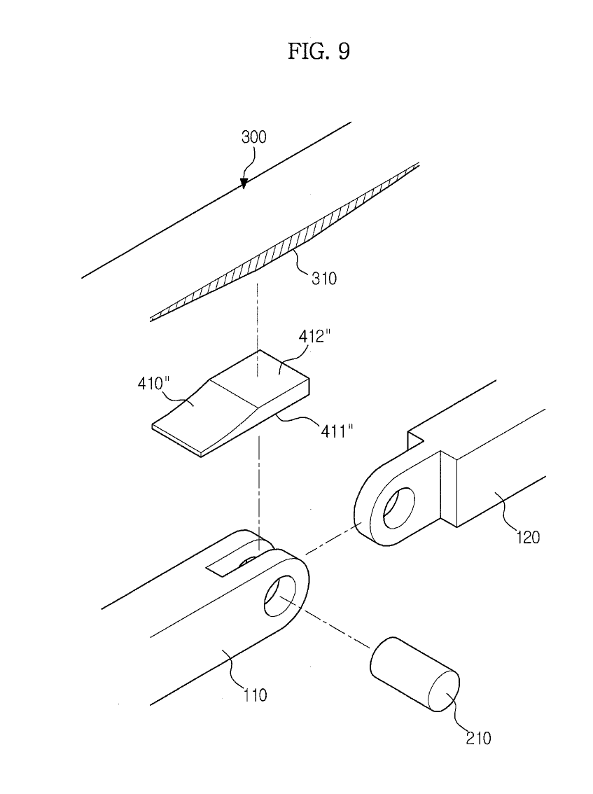

Hereinafter, modifications of the connection method of the fixing member, the link member, and the joint hinge of FIG. 4 will be described with reference to FIGS. 8 and 9.

As shown in FIG. 8, a fixing member 410′ includes a first fixing part 411′ fixed to a joint hinge 210 between plural link members 110 and 120, and a second fixing part 412′ contacting a first thickness part 310 of an outer cover member 300.

That is, the fixing member 410′ is manufactured such that it may be fixed to the plural link members 110 and 120 by the joint hinge 210. The fixing member 410′ is fixed to the plural link members 110 and 120 such that the fixing member 410′ may be rotated around the joint hinge 210, thereby being capable of preventing the first thickness part 310 of the outer cover member 300 from being separated from the second fixing part 412′ of the fixing member 410′ (or the joint hinge 210).

Further, as shown in FIG. 9, a fixing member 410″ includes a first fixing part 411″ fixed to one link member 110 of plural link members 110 and 120 connected by a joint hinge 210, and a second fixing part 412″ contacting a first thickness part 310 of an outer cover member 300.

That is, the fixing member 410″ is manufactured such that it may be fixed to one link member 110 of the plural link members 110 and 120.

As is apparent from the above description, a robot in accordance with one embodiment forms a natural curved line through a thickness variation of an outer cover member such that a user feels friendly toward gestures expressed by the robot, thereby achieving feeling expression or intention expression through non-verbal communication.

Although a few embodiments have been shown and described, it would be appreciated by those skilled in the art that changes may be made in these embodiments without departing from the principles and spirit of the embodiments, the scope of which is defined in the claims and their equivalents.

What is claimed is:

1. A robot comprising:
a plurality of link members;
at least one joint hinge connecting, the plurality of link members; and
an outer cover member covering the plurality of link members and the at least one joint hinge,
wherein, as the outer cover member gets close to the at least one joint hinge, the thickness of the outer cover member increases.

2. The robot according to claim 1, further comprising at least one fixing member connecting the outer cover member and the at least one joint hinge.

3. The robot according to claim 2, wherein the outer cover member includes first thickness parts corresponding to the fixing members, and at least one second thickness part having a smaller thickness than that of the first thickness parts corresponding to the plurality of link members.

4. The robot according to claim 3, wherein, as the at least one second thickness part gets distant from the fixing members, the thickness of the at least one second thickness parts decreases.

5. The robot according to claim 2, wherein the at least one fixing member is fixed between the plurality of link members by the at least one joint hinge.

6. The robot according to claim 2, wherein the at least one fixing member is fixed to one of the plurality of link members.

7. The robot according to claim 1, wherein the outer cover member is changed into a curved shape.

8. The robot according to claim 1, wherein the outer cover member is made of an elastic and flexible material.

9. The robot according to claim 2, wherein the outer cover member includes at least one first outer cover part connected to the at least one fixing member to have a designated thickness, and a second outer cover part made of an inelastic material and covering the at least one first outer cover part.

10. The robot according to claim 1, wherein the plurality of link members is provided in a rectilinear shape.

11. A robot comprising:
a plurality of link members connected by joints; and
an outer cover member covering the plurality of link members,
wherein the outer cover member has a thickness variation.

12. The robot of claim 11, wherein the thickness variation of the outer member comprises:
the outer cover member includes first thickness parts covering the joints, and second thickness parts covering the remaining parts excluding the joints; and
the first thickness parts have a greater thickness than that of the second thickness parts

13. A robot comprising:
a plurality of link members connected by joints;
an outer cover member covering the plurality of link members; and
fixing members formed corresponding to the joints between the plurality of link members and the outer cover member,
wherein the outer cover member is made of an elastic material such that, as the outer cover member gets distant from the fixing members, the thickness of the outer cover member decreases.
